(19) United States
(12) Patent Application Publication
(10) Pub. No.: US 2025/0170757 A1
(43) Pub. Date: May 29, 2025

(54) METHODS AND ENVIRONMENTS FOR DEVELOPING PATH PLANS FOR ROLLOUT COMPACTION OF COMPOSITE PLIES DURING COMPOSITE MANUFACTURING

(71) Applicants: The Boeing Company, Arlington, VA (US); University of Southern California, Los Angeles, CA (US)

(72) Inventors: Brice A. Johnson, Toledo, WA (US); Brian J. Smith, Seattle, WA (US); Sangvavann Heng, Buena Park, CA (US); Christopher R. Brown, Seattle, WA (US); Lisa C. Zgherea, Auburn, WA (US); Erik N. Wienhold, Seattle, WA (US); Ricardo A. Fritzke, Sammamish, WA (US); Troy Winfree, Seattle, WA (US); Satyandra Kumar Gupta, Los Angeles, CA (US); Alec Christopher Kanyuck, Laurel, MD (US); Minseok Jeon, Los Angeles, CA (US)

(73) Assignees: The Boeing Company, Arlington, VA (US); University of Southern California, Los Angeles, CA (US)

(21) Appl. No.: 18/892,663

(22) Filed: Sep. 23, 2024

Related U.S. Application Data
(60) Provisional application No. 63/603,707, filed on Nov. 29, 2023.

(51) Int. Cl. B28B 23/02; B28B 17/00; C04B 35/80; G06F 30/17

(52) U.S. Cl. CPC B28B 23/02; B28B 17/0081; C04B 35/80; G06F 30/17; C04B 2235/5252; C04B 2235/604

(57) ABSTRACT

A method for developing a path plan for rollout compaction of a composite ply during composite manufacturing includes receiving ply parametric data based on characteristics of a ceramic matrix composite ply for placement on a layup tool and subsequent compaction using a compaction roller during the composite manufacturing and generating the path plan for automated manipulation of the compaction roller to compact the ceramic matrix composite ply on the layup tool based at least in part on the ply parametric data. A path planning development environment associated with the method includes at least one computing device with a processor and associated memory, a network interface, an application program storage device and a data storage device. Various examples of the method and the path planning development environment are disclosed.

### PRIORITY

This application claims priority from U.S. Ser. No. 63/603,707 filed on Nov. 29, 2023, the entire contents of which are incorporated herein by reference.

### GOVERNMENT CONTRACT

This invention was made with Government support under contract number ARM-TEC-21-02-F-34 awarded by the Department of Defense. The government has certain rights in this invention.

### FIELD

The present disclosure relates generally to development of path plans for rollout compaction of composite plies during composite manufacturing and, particularly, for rollout compaction of ceramic matrix composite plies. The path plans are designed for implementation using automated compaction rollers in a composite manufacturing layup cell. For example, a given path plan can be tailored to a select ceramic matrix composite ply, a select layup tool and a select orientation of the ceramic matrix composite ply on the layup tool. The path plans have applications relating to various industries and products such as aircraft as well as other types of vehicles and transportation equipment. Applications in the manufacture of various other types of products with composite parts are also contemplated.

### BACKGROUND

Currently, compaction of ceramic matrix composite plies on layup tools is a manual operation performed using compaction roller hand tools. Existing manual compaction operations also include the use of sweeps, hand pressure and vacuum bags, generally ply by ply. This results in variable quality and inconsistencies in the compaction. The manual operations using the compaction roller hand tools require skilled technicians. Additionally, such manual operations are time intensive, require inspection and rework and lead to overall increased life cycle time for compaction of the ceramic matrix composite ply on the layup tool.

Accordingly, those skilled in the art continue with research and development efforts to introduce automated techniques for compaction of certain composite plies on layup tools, particularly ceramic matrix composite plies.

### SUMMARY

Disclosed are examples of methods and path planning development environments for developing path plans for rollout compaction of composite plies during composite manufacturing. The following is a non-exhaustive list of examples, which may or may not be claimed, of the subject matter according to the present disclosure.

In an example, the disclosed method for developing a path plan for rollout compaction of a composite ply during composite manufacturing includes: (1) receiving ply parametric data based on characteristics of a ceramic matrix composite ply for placement on a layup tool and subsequent compaction using a compaction roller during the composite manufacturing; and (2) generating the path plan for automated manipulation of the compaction roller to compact the ceramic matrix composite ply on the layup tool based at least in part on the ply parametric data.

In an example, the disclosed path planning development environment for developing a path plan for rollout compaction of a composite ply during composite manufacturing includes at least one computing device. The at least one computing device includes at least one processor and associated memory, a network interface, at least one application program storage device and at least one data storage device. The network interface in operative communication with the at least one processor and a communication network. The at least one application program storage device in operative communication with the at least one processor. The at least one application program storage device storing a path planning application program. The at least one data storage device in operative communication with the at least one processor. The at least one processor and the network interface are configured to receive ply parametric data based on characteristics of a ceramic matrix composite ply for placement on a layup tool and subsequent compaction using a compaction roller during the composite manufacturing. The at least one processor is configured to store the ply parametric data in the at least one data storage device. The at least one processor is configured to generate the path plan for automated manipulation of the compaction roller to compact the ceramic matrix composite ply on the layup tool based at least in part on the ply parametric data.

In another example, the disclosed method for developing a path plan for rollout compaction of a composite ply during composite manufacturing includes: (1) selecting a ceramic matrix composite ply for which the path plan is to be developed from a plurality of ceramic matrix composite plies; (2) selecting an orientation of the ceramic matrix composite ply from a plurality of orientations; (3) selecting a layup tool for which the path plan is to be developed from a plurality of layup tools; (4) receiving ply parametric data based on characteristics of the ceramic matrix composite ply for placement on the layup tool and subsequent compaction using a compaction roller during the composite manufacturing; (5) receiving tool design data providing dimensional characteristics of a working surface for the layup tool; (6) generating the path plan for automated manipulation of the compaction roller to compact the ceramic matrix composite ply on the layup tool based at least in part on the ply parametric data and the tool design data; (7) at least temporarily storing the path plan in a path plan data file; (8) sending the path plan data file to a working path plan repository accessible to a path plan test bed, wherein the path plan test bed includes the layup tool, the ceramic matrix composite ply placed on the layup tool, a test robot control system, a robotic arm controlled by the test robot control system and an end effector on the robotic arm, wherein the end effector includes the compaction roller; (9) running a compaction application program on the test robot control system of the path plan test bed, the compaction application program using the path plan data file from the working path plan repository for compaction of the ceramic matrix composite ply on the layup tool; and (10) evaluating the compaction of the ceramic matrix composite ply on the layup tool to validate the path plan data file complies with predetermined requirements for the ceramic matrix composite ply and the layup tool.

Other examples of the disclosed methods and path planning development environments for developing path plans for rollout compaction of composite plies during composite manufacturing will become apparent from the following detailed description, the accompanying drawings and the appended claims.

### BRIEF DESCRIPTION OF THE DRAWINGS

FIG. 1 is a flow diagram of an example of a method for developing a path plan for rollout compaction of a composite ply during composite manufacturing;

FIG. 2 is a flow diagram of an example of the generating of the path plan for the method of FIG. 1;

FIG. 3, in combination with FIG. 2, is a flow diagram of another example of the generating of the path plan for the method of FIG. 1;

FIG. 4 is a flow diagram of yet another example of the generating of the path plan for the method of FIG. 1;

FIG. 5, in combination with FIG. 4, is a flow diagram of still another example of the generating of the path plan for the method of FIG. 1;

FIG. 6, in combination with FIG. 1, is a flow diagram of another example of a method for developing a path plan for rollout compaction of a composite ply during composite manufacturing;

FIG. 7, in combination with FIGS. 1 and 6, is a flow diagram of yet another example of a method for developing a path plan for rollout compaction of a composite ply during composite manufacturing;

FIG. 8, in combination with FIGS. 1, 6 and 7, is a flow diagram of still another example of a method for developing a path plan for rollout compaction of a composite ply during composite manufacturing;

FIG. 9, in combination with FIGS. 1 and 6, is a flow diagram of still yet another example of a method for developing a path plan for rollout compaction of a composite ply during composite manufacturing;

FIG. 10, in combination with FIGS. 1 and 6, is a flow diagram of another example of a method for developing a path plan for rollout compaction of a composite ply during composite manufacturing;

FIG. 11 is a functional block diagram of an example of a path planning development environment for developing a path plan for rollout compaction of a composite ply during composite manufacturing;

FIG. 12 is a functional block diagram of an example of at least one central storage device;

FIG. 13 is a functional block diagram of an example of a path plan test bed;

FIG. 14 is a functional block diagram of an example of composite manufacturing layup cell;

FIGS. 15A-D are functional diagrams of examples of composite plies in which reinforcement fibers are at a zero-degree orientation, a 45-degree orientation, a 90-degree orientation and a −45-degree orientation;

FIGS. 16A-B is a flow diagram of yet another example of a method for developing a path plan for rollout compaction of a composite ply during composite manufacturing;

FIG. 17 is a block diagram of aircraft production and service methodology; and

FIG. 18 is a schematic illustration of an aircraft.

### DETAILED DESCRIPTION

Various examples of methods and path planning development environments for developing path plans for rollout compaction of composite plies during composite manufacturing are disclosed herein. The various examples provide techniques for automated robotic path planning using inputs from geometric tooling features, ply geometry and ply material specific processing parameters. The path planning techniques include identification of compaction paths and sequences, traversing fabric weave (e.g., reinforcement fibers) on first paths and potential selection of a back-and-forth yaw motion (e.g., a yaw-saw motion) for certain paths that present complex geometric tooling features. For example, the resulting path plans provide a fully automated process for ceramic matrix composites from programming to ply layup.

Various examples of the methods disclosed herein refer to composite plies. The composite plies are formed by cutting woven fabric to a desired size for the rollout compaction on a layup tool. The woven fabric can be in various weave styles. For example, the fabric may have an orthogonal weave of zero-degree and 90-degree fibers in the warp and weft directions. Where a single fiber orientation is referenced below, it is understood to refer to a primary fiber of an interwoven fabric that also includes at least one secondary fiber. The single fiber orientation described may be based on the warp fibers, the weft fibers or any directional set of interwoven fibers.

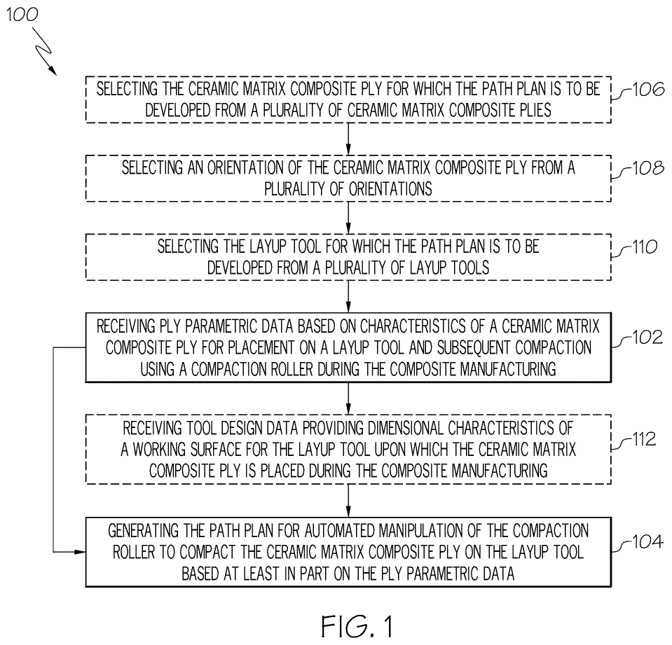

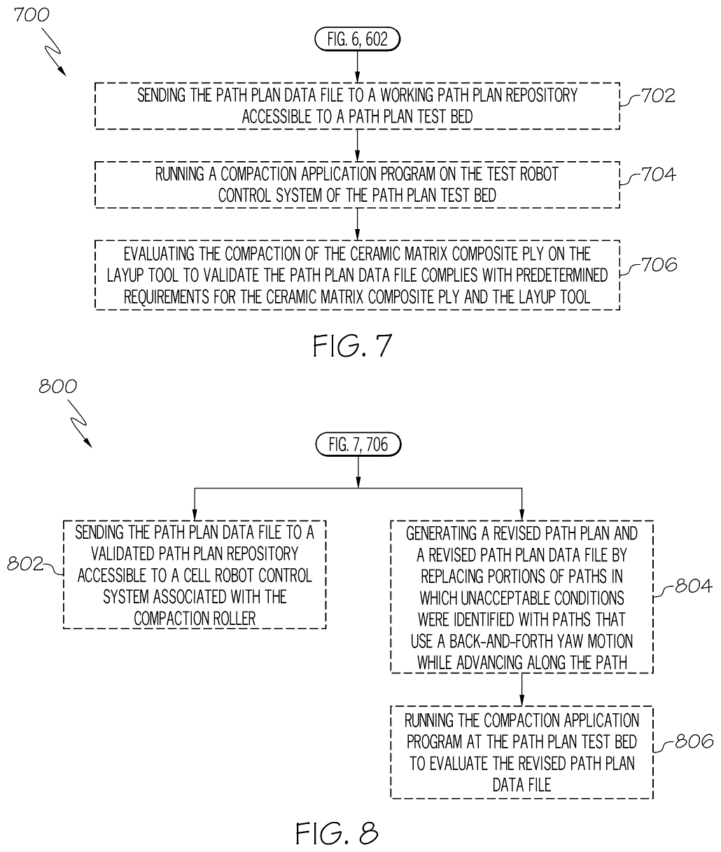

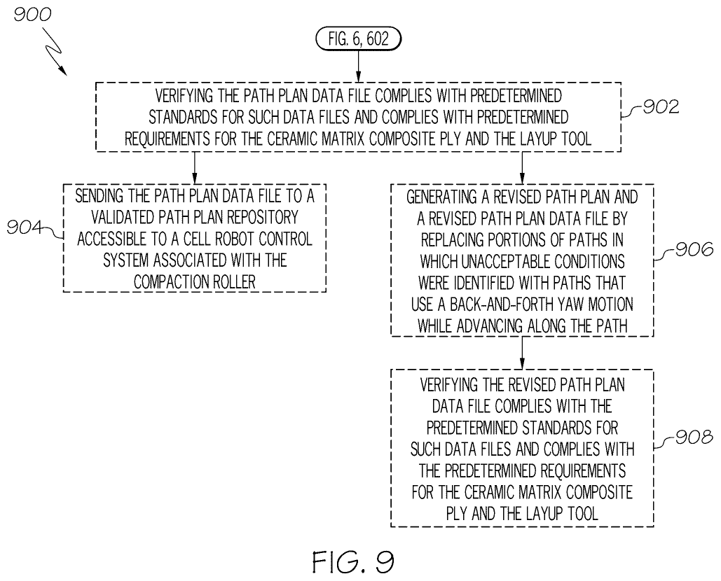

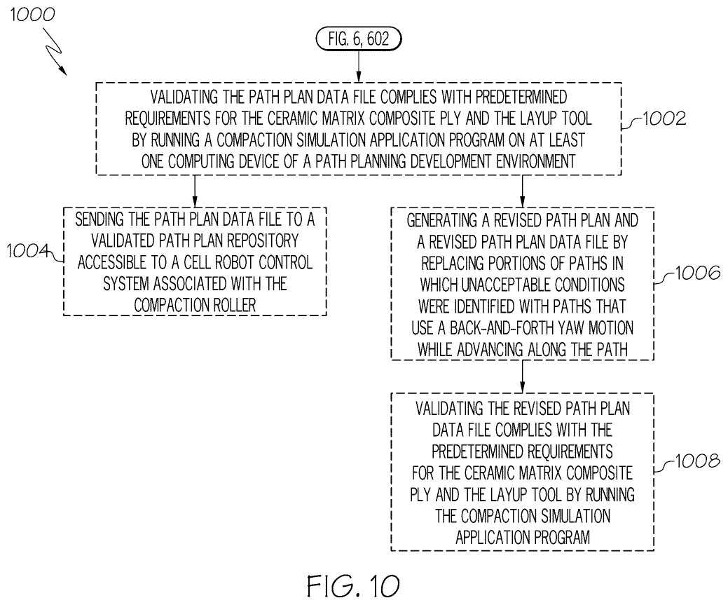

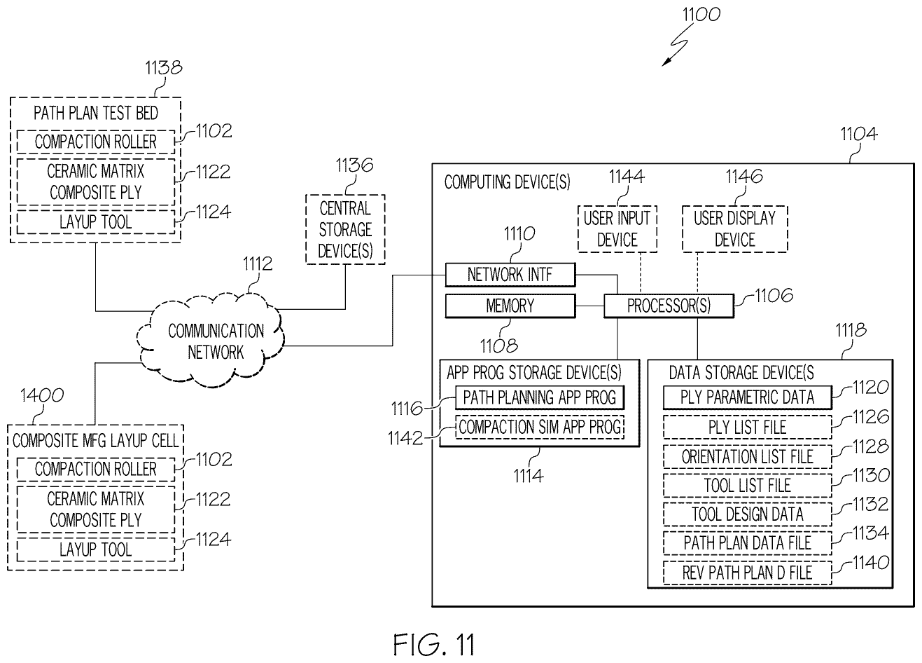

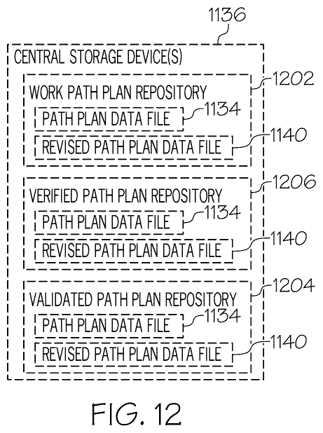

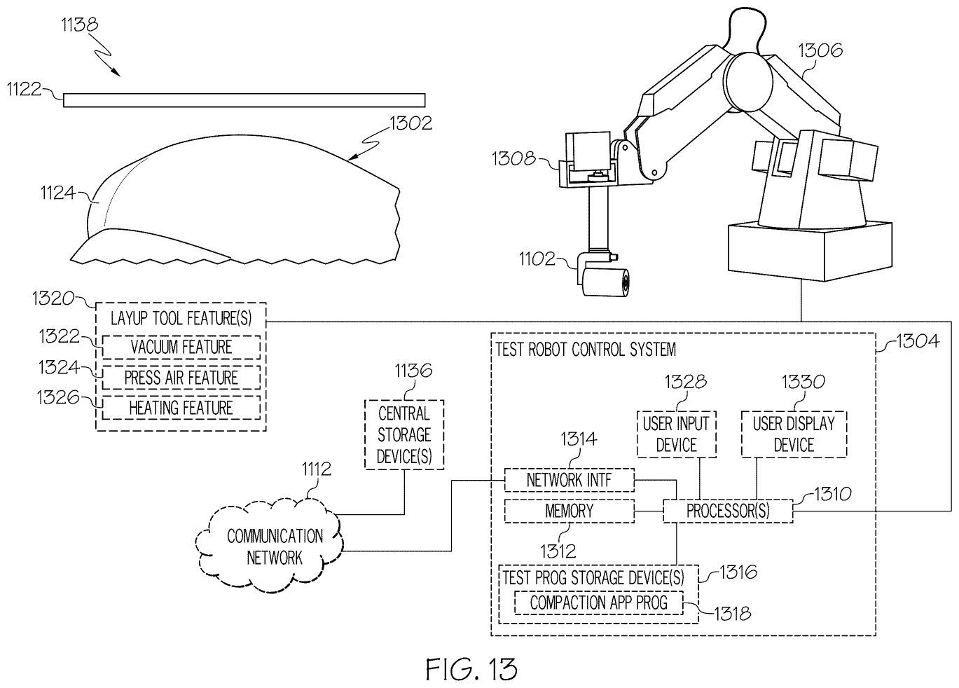

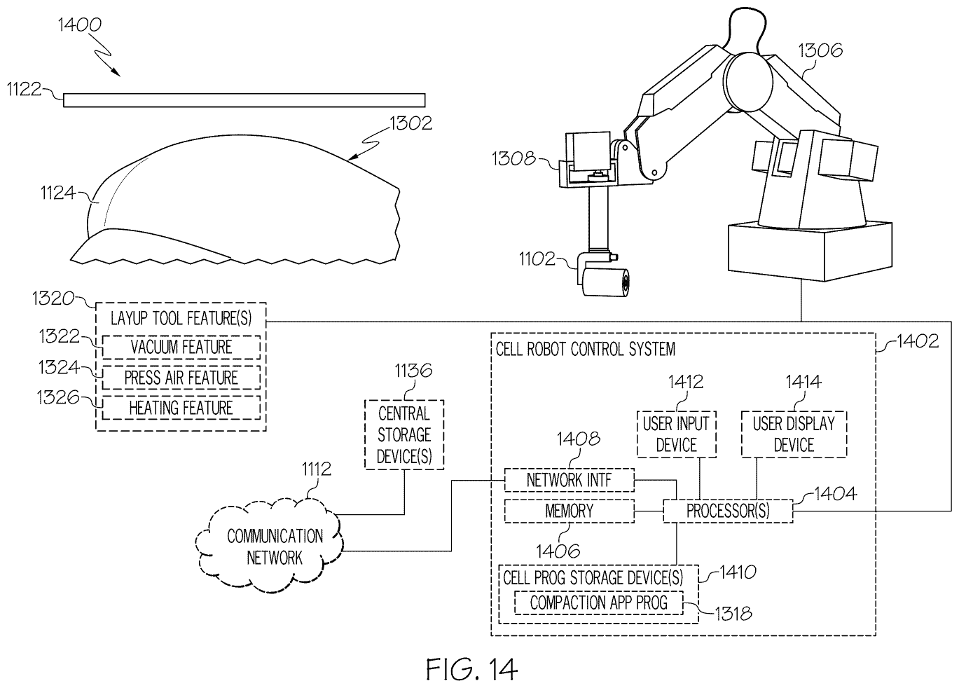

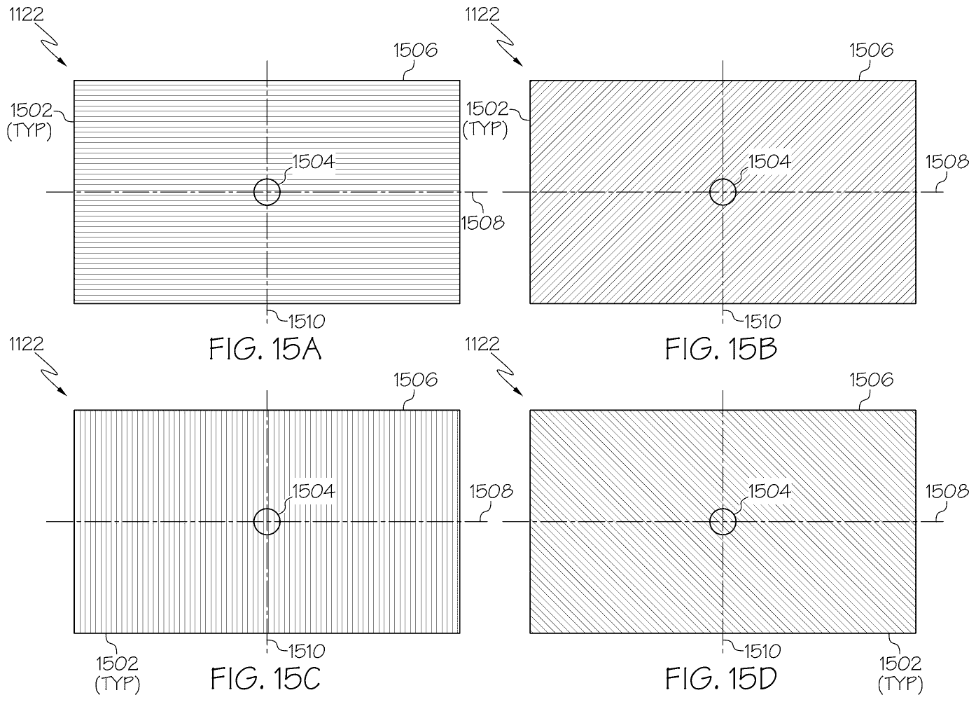

Referring generally to FIGS. 1-14 and 15A-D, by way of examples, the present disclosure is directed to a method 100, 600, 700, 800, 900, 1000 for developing a path plan for rollout compaction of a composite ply during composite manufacturing. FIGS. 1-5 disclose various example of method 100. FIG. 6, in combination with FIG. 1, discloses several examples of method 600. FIG. 7, in combination with FIGS. 1 and 6, discloses several examples of method 700. FIG. 8, in combination with FIGS. 1, 6 and 7, discloses several examples of method 800. FIG. 9, in combination with FIGS. 1 and 6, discloses several examples of method 900. FIG. 10, in combination with FIGS. 1 and 6, discloses several examples of method 1000. FIG. 11 discloses an example of a path planning development environment 1100 for developing a path plan for rollout compaction of a composite ply during composite manufacturing. FIG. 12 discloses an example of at least one central storage device 1136. FIG. 13 discloses an example of a path plan test bed 1138. FIG. 14 discloses an example of composite manufacturing layup cell 1400. FIGS. 15A-D disclose examples of ceramic matrix composite plies 1122 in which ceramic reinforcement fibers 1502 are at a zero-degree orientation, a 45-degree orientation, a 90-degree orientation and a −45-degree orientation.

With reference again to FIGS. 1-5, 11, 13 and 15, in one or more examples, a method 100 (see FIG. 1) for developing a path plan for rollout compaction of a composite ply during composite manufacturing includes receiving 102 ply parametric data 1120. The ply parametric data 1120 based on characteristics of a ceramic matrix composite ply 1122 for placement on a layup tool 1124 and subsequent compaction using a compaction roller 1102 during the composite manufacturing. At 104, the path plan is generated for automated manipulation of the compaction roller 1102 to compact the ceramic matrix composite ply 1122 on the layup tool 1124 based at least in part on the ply parametric data 1120.

In another example of the method 100, the ply parametric data 1120 includes dimensional data for the ceramic matrix composite ply 1122, geometric data for the ceramic matrix composite ply 1122, materials data for the ceramic matrix composite ply 1122, an orientation of ceramic reinforcement fibers 1502 in conjunction with placement on the layup tool 1124, characteristics of interwoven fibers within the ceramic matrix composite ply 1122, drapability characteristics of the ceramic matrix composite ply 1122, a central reference location 1504 for the ceramic matrix composite ply 1122, a longitudinal axis 1508 for the ceramic matrix composite ply 1122 intersecting the central reference location 1504, a transverse axis 1510 for the ceramic matrix composite ply 1122 intersecting the central reference location 1504, a maximum shear for the ceramic matrix composite ply 1122, a maximum angle of distortion for the ceramic matrix composite ply 1122, predetermined thresholds for the ceramic matrix composite ply 1122 relating to the ply parametric data 1120 or any other suitable type of ply parametric data in any suitable combination.

In yet another example of the method 100, the ceramic matrix composite ply 1122 includes ceramic reinforcement fibers 1502 and a ceramic matrix. In a further example, the ceramic reinforcement fibers 1502 include carbon reinforcement fibers, silicon carbide reinforcement fibers, alumina reinforcement fibers, alumina silica reinforcement fibers or any other type of ceramic reinforcement fibers in any suitable combination. In another further example, the ceramic matrix includes carbon material, silicon carbide material, alumina material, alumina silica material or any other suitable type of ceramic matrix material in any suitable combination. In yet another further example, the ceramic matrix is deposited on the ceramic reinforcement fibers 1502 to form the ceramic matrix composite.

In still another example of the method 100, the layup tool 1124 includes a working surface 1302 upon which the ceramic matrix composite ply 1122 is placed during the composite manufacturing. In a further example, the working surface 1302 of the layup tool 1124 is three-dimensional. In another further example, the working surface 1302 of the layup tool 1124 includes a curved portion, a double curved portion, a contoured portion, a geometrically-shaped portion, a rising ramp portion, a falling ramp portion, a two-dimensional portion or any other suitable shaped portion in any suitable combination.

In still yet another example of the method 100, the compaction roller 1102 includes an approximately three inch roller, a roller having a width ranging between approximately two inches and approximately four inches, a roller having a width ranging between approximately five inches and approximately seven inches, a roller having a width ranging between approximately eight inches and approximately ten inches, a roller having a width ranging between approximately eleven inches and approximately thirteen inches or any other suitable compaction roller. In another example of the method 100, the compaction roller 1102 includes an automated compaction roller 1102. In yet another example of the method 100, the compaction roller 1102 includes at least a portion of an end effector 1308 for a robotic arm 1306. In still another example of the method 100, the composite manufacturing includes ceramic matrix composite manufacturing.

In still yet another example of the method 100, the automated manipulation includes maneuvering the compaction roller 1102 along the path plan using a robotic arm 1306. The compaction roller 1102 being at least a portion of an end effector 1308 on the robotic arm 1306. In another example of the method 100, the generating 104 of the path plan is performed by at least one computing device 1104 using a path planning development environment 1100 to create a path plan data file 1134 tailored for compaction of the ceramic matrix composite ply 1122 on the layup tool 1124 using the compaction roller 1102.

In yet another example, the method 100 also includes selecting 106 the ceramic matrix composite ply 1122 for which the path plan is to be developed from a plurality of ceramic matrix composite plies. At 108, an orientation of the ceramic matrix composite ply 1122 is selected from a plurality of orientations. In a further example, the plurality of orientations include a zero-degree orientation, a 45-degree orientation, a 60-degree orientation, a 90-degree orientation, a −45-degree orientation, a −60-degree orientation or another other suitable orientation.

In still another example, the method 100 also includes selecting 110 the layup tool 1124 for which the path plan is to be developed from a plurality of layup tools. In still yet another example, the method 100 also includes receiving 112 tool design data 1132 providing dimensional characteristics of a working surface 1302 for the layup tool 1124 upon which the ceramic matrix composite ply 1122 is placed during the composite manufacturing. In this example, the generating 104 of the path plan for automated manipulation of the compaction roller 1102 is based at least in part on the tool design data 1132. In a further example, the tool design data 1132 includes a three-dimensional design model of the layup tool 1124, a three-dimensional design model of a working surface 1302 of the layup tool 1124, dimensional data for the working surface 1302, geometric data for the working surface 1302, contours of the working surface 1302, characteristics of controllable features 1320 of the layup tool 1124 or any other suitable type of design data in any suitable combination. In an even further example, the controllable features 1320 of the layup tool 1124 include a vacuum feature 1322, a pressurized air feature 1324, a heating feature 1326 or any other suitable controllable feature in any suitable combination.

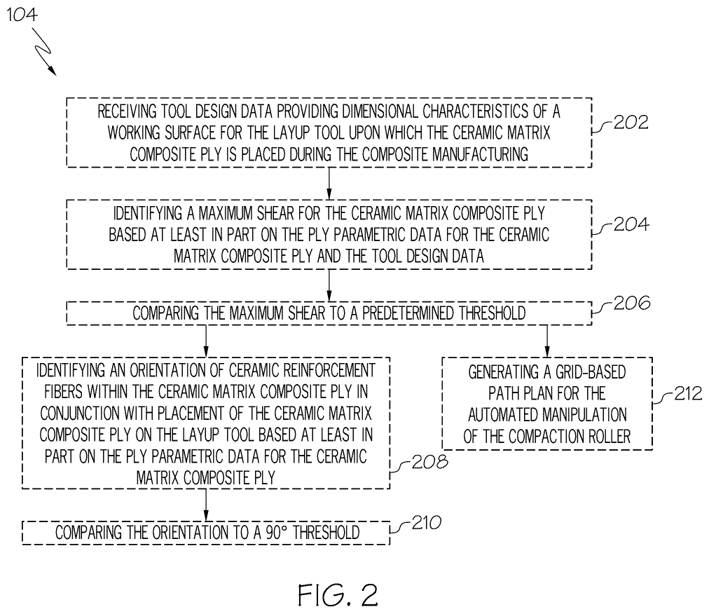

In another example of the method 100, the generating 104 of the path plan includes receiving 202 (see FIG. 2) tool design data 1132 providing dimensional characteristics of a working surface 1302 for the layup tool 1124 upon which the ceramic matrix composite ply 1122 is placed during the composite manufacturing. At 204, a maximum shear for the ceramic matrix composite ply 1122 is identified based at least in part on the ply parametric data 1120 for the ceramic matrix composite ply 1122 and the tool design data 1132. At 206, the maximum shear is compared to a predetermined threshold.

In a further example, the predetermined threshold includes a range of angular measure. In an even further example, the range of angular measure includes approximately five degrees to approximately fifteen degrees, approximately six degrees to approximately fourteen degrees, approximately seven degrees to approximately thirteen degrees, approximately eight degrees to approximately twelve degrees, approximately nine degrees to approximately eleven degrees or any other suitable range of angular measure.

In another further example, where the maximum shear is greater than the predetermined threshold, the generating 104 of the path plan also includes identifying 208 an orientation of ceramic reinforcement fibers 1502 within the ceramic matrix composite ply 1122 in conjunction with placement of the ceramic matrix composite ply 1122 on the layup tool 1124 based at least in part on the ply parametric data 1120 for the ceramic matrix composite ply 1122. At 210, the orientation of the ceramic reinforcement fibers 1502 is compared to a 90° threshold.

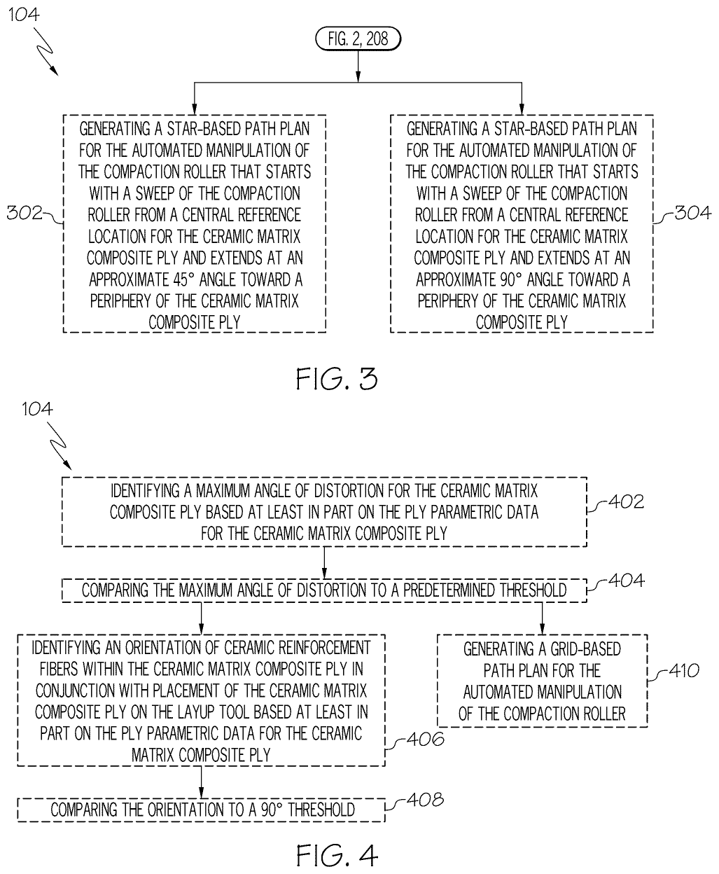

In an even further example, where the orientation of the ceramic reinforcement fibers 1502 is 90°, the generating 104 of the path plan also includes generating 302 (see FIG. 3) a star-based path plan for the automated manipulation of the compaction roller 1102 that starts with a sweep of the compaction roller 1102 from a central reference location 1504 for the ceramic matrix composite ply 1122 and extends at an approximate 45° angle toward a periphery 1506 of the ceramic matrix composite ply 1122. The sweep being between a longitudinal axis 1508 of the layup tool 1124 and a transverse axis 1510 of the layup tool 1124 that intersect at the central reference location 1504 for the ceramic matrix composite ply 1122. In an even yet further example, the generating 302 of the star-based path plan continues with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another even further example, where the orientation of the ceramic reinforcement fibers 1502 is not 90°, the generating 104 of the path plan also includes generating 304 a star-based path plan for the automated manipulation of the compaction roller 1102 that starts with a sweep of the compaction roller 1102 from a central reference location 1504 for the ceramic matrix composite ply 1122 and extends at an approximate 90° angle toward a periphery 1506 of the ceramic matrix composite ply 1122. The sweep being along a longitudinal axis 1508 of the layup tool 1124 or a transverse axis 1510 of the layup tool 1124. The longitudinal axis 1508 and the transverse axis 1510 intersect at the central reference location 1504 for the ceramic matrix composite ply 1122. In an even yet further example, the generating 304 of the star-based path plan continues with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In yet another further example, where the maximum shear is not greater than the predetermined threshold, the generating 104 of the path plan also includes generating 212 (see FIG. 2) a grid-based path plan for the automated manipulation of the compaction roller 1102. The grid-based path plan includes sweeps of the compaction roller 1102 from a longitudinal axis 1508 of the ceramic matrix composite ply 1122 or a transverse axis 1510 of the ceramic matrix composite ply 1122 toward a periphery 1506 of the ceramic matrix composite ply 1122, the sweeps initially starting from a central reference location 1504 for the ceramic matrix composite ply 1122. The longitudinal axis 1508 and the transverse axis 1510 intersect at the central reference location 1504 for the ceramic matrix composite ply 1122. In an even further example, the generating 212 of the grid-based path plan continues with additional sweeps of the compaction roller 1102 along the longitudinal axis 1508 or the transverse axis 1510. The additional sweeps being toward the periphery 1506 of the ceramic matrix composite ply 1122 from various locations along the longitudinal axis 1508 or the transverse axis 1510 until the ceramic matrix composite ply 1122 is compacted on the layup tool 1124.

In yet another example of the method 100, the generating 104 of the path plan includes identifying 402 (see FIG. 4) a maximum angle of distortion for the ceramic matrix composite ply 1122 based at least in part on the ply parametric data 1120 for the ceramic matrix composite ply 1122. At 404, the maximum angle of distortion is compared to a predetermined threshold.

In a further example, the predetermined threshold includes a range of angular measure. In an even further example, the range of angular measure includes approximately five degrees to approximately fifteen degrees, approximately six degrees to approximately fourteen degrees, approximately seven degrees to approximately thirteen degrees, approximately eight degrees to approximately twelve degrees, approximately nine degrees to approximately eleven degrees or any other suitable range of angular measure.

In another further example, where the maximum angle of distortion is greater than the predetermined threshold, the generating 104 of the path plan also includes identifying 406 an orientation of ceramic reinforcement fibers 1502 within the ceramic matrix composite ply 1122 in conjunction with placement of the ceramic matrix composite ply 1122 on the layup tool 1124 based at least in part on the ply parametric data 1120 for the ceramic matrix composite ply 1122. At 408, the orientation of the ceramic reinforcement fibers 1502 is compared to a 90° threshold.

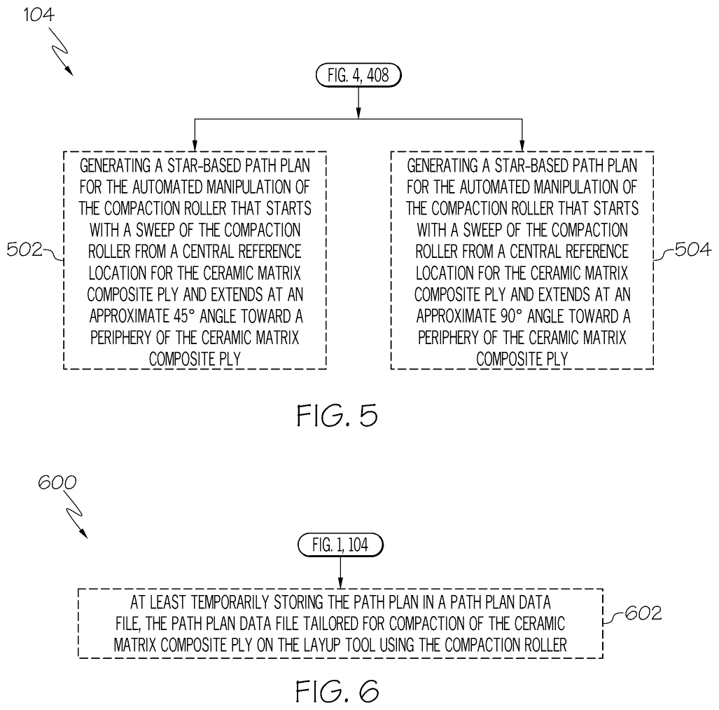

In an even further example, where the orientation of the ceramic reinforcement fibers 1502 is 90°, the generating 104 of the path plan also includes generating 502 (see FIG. 5) a star-based path plan for the automated manipulation of the compaction roller 1102 that starts with a sweep of the compaction roller 1102 from a central reference location 1504 for the ceramic matrix composite ply 1122 and extends at an approximate 45° angle toward a periphery 1506 of the ceramic matrix composite ply 1122. The sweep being between a longitudinal axis 1508 of the layup tool 1124 and a transverse axis 1510 of the layup tool 1124 that intersect at the central reference location 1504 for the ceramic matrix composite ply 1122. In an even yet further example, the generating 502 of the star-based path plan continues with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another even further example, where the orientation of the ceramic reinforcement fibers 1502 is not 90°, the generating 104 of the path plan also includes generating 504 a star-based path plan for the automated manipulation of the compaction roller 1102 that starts with a sweep of the compaction roller 1102 from a central reference location 1504 for the ceramic matrix composite ply 1122 and extends at an approximate 90° angle toward a periphery 1506 of the ceramic matrix composite ply 1122. The sweep being along a longitudinal axis 1508 of the layup tool 1124 or a transverse axis 1510 of the layup tool 1124. The longitudinal axis 1508 and the transverse axis 1510 intersect at the central reference location 1504 for the ceramic matrix composite ply 1122. In an even yet further example, the generating 504 of the star-based path plan continues with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In yet another further example, where the maximum angle of distortion is not greater than the predetermined threshold, the generating 104 of the path plan also includes generating 410 a grid-based path plan for the automated manipulation of the compaction roller 1102. The grid-based path plan includes sweeps of the compaction roller 1102 from a longitudinal axis 1508 of the ceramic matrix composite ply 1122 or a transverse axis 1510 of the ceramic matrix composite ply 1122 toward a periphery 1506 of the ceramic matrix composite ply 1122. The sweeps initially start from a central reference location 1504 for the ceramic matrix composite ply 1122. The longitudinal axis 1508 and the transverse axis 1510 intersect at the central reference location 1504 for the ceramic matrix composite ply 1122. In an even yet further example, the generating 410 of the grid-based path plan continues with additional sweeps of the compaction roller 1102 along the longitudinal axis 1508 or the transverse axis 1510, the additional sweeps being toward the periphery 1506 of the ceramic matrix composite ply 1122 from various locations along the longitudinal axis 1508 or the transverse axis 1510 until the ceramic matrix composite ply 1122 is compacted on the layup tool 1124.

With reference again to FIGS. 1, 6 and 11, in one or more examples, a method 600 (see FIG. 6) for developing a path plan for rollout compaction of a composite ply during composite manufacturing includes the method 100 (see FIG. 1) described above. In one example, the method 600 continues from 104 of FIGS. 1 to 602 where the path plan is at least temporarily stored in a path plan data file 1134. The path plan data file 1134 tailored for compaction of the ceramic matrix composite ply 1122 on the layup tool 1124 using the compaction roller 1102.

With reference again to FIGS. 1, 6, 7, 11 and 12, in one or more examples, a method 700 (see FIG. 7) for developing a path plan for rollout compaction of a composite ply during composite manufacturing includes the methods 100, 600 (see FIGS. 1 and 6) described above. In one example, the method 600 continues from 602 of FIGS. 6 to 702 where the path plan data file 1134 is sent to a working path plan repository 1202 accessible to a path plan test bed 1138. The path plan test bed 1138 includes the layup tool 1124, the ceramic matrix composite ply 1122 placed on the layup tool 1124, a test robot control system 1304, a robotic arm 1306 controlled by the test robot control system 1304 and an end effector 1308 on the robotic arm 1306. The end effector 1308 includes the compaction roller 1102. At 704, a compaction application program 1318 is run on the test robot control system 1304 of the path plan test bed 1138. The compaction application program 1318 uses the path plan data file 1134 from the working path plan repository 1202 for compaction of the ceramic matrix composite ply 1122 on the layup tool 1124. At 706, the compaction of the ceramic matrix composite ply 1122 on the layup tool 1124 is evaluated to validate the path plan data file 1134 complies with predetermined requirements for the ceramic matrix composite ply 1122 and the layup tool 1124. In another example of the method 700, the evaluating 706 of the compaction includes a visual inspection of the compaction, visual imaging of the compaction, analysis of the compaction, comparison of contours of the compacted ceramic matrix composite ply 1122 to contours of the layup tool 1124 or any other suitable type of evaluation in any suitable combination.

With reference again to FIGS. 1, 6-8 and 11-14, in one or more examples, a method 800 (see FIG. 8) for developing a path plan for rollout compaction of a composite ply during composite manufacturing includes the methods 100, 600, 700 (see FIGS. 1, 6 and 7) described above. In this example, the evaluating 706 of the compaction is successful and the method 800 continues from 706 of FIGS. 7 to 802 where the path plan data file 1134 is sent to a validated path plan repository 1204 accessible to a cell robot control system 1402 of a composite manufacturing layup cell 1400. The cell robot control system 1402 is associated with the compaction roller 1102. In another example, the evaluating 706 of the compaction is not successful and the method 800 continues from 706 of FIGS. 7 to 804 where a revised path plan and a revised path plan data file 1140 are generated by replacing portions of paths in which unacceptable conditions were identified with paths that use a back-and-forth yaw motion while advancing along the path. At 806, the compaction application program 1318 is run at the path plan test bed 1138 to evaluate the revised path plan data file 1140.

With reference again to FIGS. 1, 6, 9, 11, 12 and 14, in one or more examples, a method 900 (see FIG. 9) for developing a path plan for rollout compaction of a composite ply during composite manufacturing includes the methods 100, 600 (see FIGS. 1 and 6) described above. In one example, the method 900 continues from 602 of FIGS. 6 to 902 for verification the path plan data file 1134 complies with predetermined standards for such data files and complies with predetermined requirements for the ceramic matrix composite ply 1122 and the layup tool 1124. In another example of the method 900, the verifying 902 of the path plan data file 1134 includes a visual inspection of the path plan data file 1134, processing the path plan data file 1134 for syntax errors, processing the path plan data file 1134 to confirm compliance with ceramic matrix composite ply 1122 requirements, processing the path plan data file 1134 to confirm compliance with layup tool requirements or any other suitable type of verification in any suitable combination. In yet another example, where the verifying 902 of the path plan data file 1134 is successful, the method 900 also includes sending 904 the path plan data file 1134 to a verified path plan repository 1206 accessible to a cell robot control system 1402 associated with the compaction roller 1102. In still another example, where the verifying 902 of the path plan data file 1134 is not successful, the method 900 also includes generating 906 a revised path plan and a revised path plan data file 1140 by replacing portions of paths in which unacceptable conditions were identified with paths that use a back-and-forth yaw motion while advancing along the path. At 908, the revised path plan data file 1140 is verified for compliance with the predetermined standards for such data files and compliance with the predetermined requirements for the ceramic matrix composite ply 1122 and the layup tool 1124.

With reference again to FIGS. 1, 6, 10-12 and 14, in one or more examples, a method 1000 (see FIG. 10) for developing a path plan for rollout compaction of a composite ply during composite manufacturing includes the methods 100, 600 (see FIGS. 1 and 6) described above. In one example, the method 1000 continues from 602 of FIGS. 6 to 1002 for validation the path plan data file 1134 complies with predetermined requirements for the ceramic matrix composite ply 1122 and the layup tool 1124 by running a compaction simulation application program 1142 on at least one computing device 1104 of a path planning development environment 1100. The at least one computing device 1104 having access to the path plan data file 1134. In another example, where the validating 1002 of the path plan data file 1134 is successful, the method 1000 also includes sending 1004 the path plan data file 1134 to a validated path plan repository 1204 accessible to a cell robot control system 1402 of a composite manufacturing layup cell 1400. The cell robot control system 1402 is associated with the compaction roller 1102. In yet another example, where the validating 1002 of the path plan data file 1134 is not successful, the method 1000 also includes generating 1006 a revised path plan and a revised path plan data file 1140 by replacing portions of paths in which unacceptable conditions were identified with paths that use a back-and-forth yaw motion while advancing along the path. At 1008, the revised path plan data file 1140 is validated to comply with the predetermined requirements for the ceramic matrix composite ply 1122 and the layup tool 1124 by running the compaction simulation application program 1142.

Referring generally to FIGS. 11-14 and 15A-D, by way of examples, the present disclosure is directed to a path planning development environment 1100 for developing a path plan for rollout compaction of a composite ply during composite manufacturing. FIG. 11 discloses an example of the path planning development environment 1100 for developing a path plan for rollout compaction of a composite ply during composite manufacturing. FIG. 12 discloses an example of at least one central storage device 1136. FIG. 13 discloses an example of a path plan test bed 1138. FIG. 14 discloses an example of composite manufacturing layup cell 1400. FIGS. 15A-D disclose examples of ceramic matrix composite plies 1122 in which ceramic reinforcement fibers 1502 are at a zero-degree orientation, a 45-degree orientation, a 90-degree orientation and a −45-degree orientation.

With reference again to FIGS. 11-14 and 15A-D, in one or more examples, a path planning development environment 1100 includes at least one computing device 1104. The at least one computing device 1104 includes at least one processor 1106 and associated memory 1108, a network interface 1110, at least one application program storage device 1114 and at least one data storage device 1118. The network interface 1110 in operative communication with the at least one processor 1106 and a communication network 1112. The at least one application program storage device 1114 in operative communication with the at least one processor 1106. The at least one application program storage device 1114 storing a path planning application program 1116. The at least one data storage device 1118 in operative communication with the at least one processor 1106. The at least one processor 1106 and the network interface 1110 are configured to receive ply parametric data 1120 based on characteristics of a ceramic matrix composite ply 1122 for placement on a layup tool 1124 and subsequent compaction using a compaction roller 1102 during the composite manufacturing. The at least one processor 1106 is configured to store the ply parametric data 1120 in the at least one data storage device 1118. The at least one processor 1106 is configured to generate the path plan for automated manipulation of the compaction roller 1102 to compact the ceramic matrix composite ply 1122 on the layup tool 1124 based at least in part on the ply parametric data 1120.

In another example of the path planning development environment 1100, the at least one data storage device 1118 stores a ply list file 1126 identifying a plurality of ceramic matrix composite plies and an orientation list file 1128 identifying a plurality of orientations for the plurality of ceramic matrix composite plies. The at least one processor 1106 is configured to select the ceramic matrix composite ply 1122 for which the path plan is to be developed from the plurality of ceramic matrix composite plies identified in the ply list file 1126. The at least one processor 1106 is configured to select an orientation of the ceramic matrix composite ply 1122 from the plurality of orientations identified in the orientation list file 1128.

In yet another example of the path planning development environment 1100, the at least one data storage device 1118 stores a tool list file 1130 identifying a plurality of layup tools. The at least one processor 1106 is configured to select the layup tool 1124 for which the path plan is to be developed from the plurality of layup tools identified in the tool list file 1130.

In still another example of the path planning development environment 1100, the at least one processor 1106 and the network interface 1110 are configured to receive tool design data 1132 providing dimensional characteristics of a working surface 1302 for the layup tool 1124 upon which the ceramic matrix composite ply 1122 is placed during the composite manufacturing. The at least one processor 1106 is configured to store the tool design data 1132 in the at least one data storage device 1118. The at least one processor 1106 is configured to generate the path plan for automated manipulation of the compaction roller 1102 based at least in part on the tool design data 1132.

In still yet another example of the path planning development environment 1100, the at least one processor 1106 and the network interface 1110 are configured to receive tool design data 1132 providing dimensional characteristics of a working surface 1302 for the layup tool 1124 upon which the ceramic matrix composite ply 1122 is placed during the composite manufacturing. In conjunction with generation of the path plan, the at least one processor 1106 is configured to: i) identify a maximum shear for the ceramic matrix composite ply 1122 based at least in part on the ply parametric data 1120 for the ceramic matrix composite ply 1122 and ii) compare the maximum shear to a predetermined threshold.

In a further example, in conjunction with the generation of the path plan, where the maximum shear is greater than the predetermined threshold, the at least one processor 1106 is configured to: i) identify an orientation of ceramic reinforcement fibers 1502 within the ceramic matrix composite ply 1122 in conjunction with placement of the ceramic matrix composite ply 1122 on the layup tool 1124 based at least in part on the ply parametric data 1120 for the ceramic matrix composite ply 1122 and ii) compare the orientation of the ceramic reinforcement fibers 1502 to a 90° threshold.

In an even further example, in conjunction with the generation of the path plan, where the orientation of the ceramic reinforcement fibers 1502 is 90°, the at least one processor 1106 is configured to generate a star-based path plan for the automated manipulation of the compaction roller 1102 that starts with a sweep of the compaction roller 1102 from a central reference location 1504 for the ceramic matrix composite ply 1122 and extends at an approximate 45° angle toward a periphery 1506 of the ceramic matrix composite ply 1122. The sweep being between a longitudinal axis 1508 of the layup tool 1124 and a transverse axis 1510 of the layup tool 1124 that intersect at the central reference location 1504 for the ceramic matrix composite ply 1122. In an even yet further example, the at least one processor 1106 is configured to continue generating the star-based path plan with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another even further example, in conjunction with the generation of the path plan, where the orientation of the ceramic reinforcement fibers 1502 is not 90°, the at least one processor 1106 is configured to generate a star-based path plan for the automated manipulation of the compaction roller 1102 that starts with a sweep of the compaction roller 1102 from a central reference location 1504 for the ceramic matrix composite ply 1122 and extends at an approximate 90° angle toward a periphery 1506 of the ceramic matrix composite ply 1122. The sweep being along a longitudinal axis 1508 of the layup tool 1124 or a transverse axis 1510 of the layup tool 1124. The longitudinal axis 1508 and the transverse axis 1510 intersect at the central reference location 1504 for the ceramic matrix composite ply 1122. In an even yet further example, the at least one processor 1106 is configured to continue generating the star-based path plan with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another further example, in conjunction with the generation of the path plan, where the maximum shear is not greater than the predetermined threshold, the at least one processor 1106 is configured to generate a grid-based path plan for the automated manipulation of the compaction roller 1102. The grid-based path plan including sweeps of the compaction roller 1102 from a longitudinal axis 1508 of the ceramic matrix composite ply 1122 or a transverse axis 1510 of the ceramic matrix composite ply 1122 toward a periphery 1506 of the ceramic matrix composite ply 1122. The sweeps initially start from a central reference location 1504 for the ceramic matrix composite ply 1122. The longitudinal axis 1508 and the transverse axis 1510 intersect at the central reference location 1504 for the ceramic matrix composite ply 1122. In an even further example, the at least one processor 1106 is configured to continue generating the grid-based path plan with additional sweeps of the compaction roller 1102 along the longitudinal axis 1508 or the transverse axis 1510. The additional sweeps being toward the periphery 1506 of the ceramic matrix composite ply 1122 from various locations along the longitudinal axis 1508 or the transverse axis 1510 until the ceramic matrix composite ply 1122 is compacted on the layup tool 1124.

In another example of the path planning development environment 1100, in conjunction with generation of the path plan, the at least one processor 1106 is configured to: i) identify a maximum angle of distortion for the ceramic matrix composite ply 1122 based at least in part on the ply parametric data 1120 for the ceramic matrix composite ply 1122 and ii) compare the maximum angle of distortion to a predetermined threshold.

In a further example, in conjunction with the generation of the path plan, where the maximum angle of distortion is greater than the predetermined threshold, the at least one processor 1106 is configured to: i) identify an orientation of ceramic reinforcement fibers 1502 within the ceramic matrix composite ply 1122 in conjunction with placement of the ceramic matrix composite ply 1122 on the layup tool 1124 based at least in part on the ply parametric data 1120 for the ceramic matrix composite ply 1122 and ii) compare the orientation of the ceramic reinforcement fibers 1502 to a 90° threshold.

In an even further example, in conjunction with the generation of the path plan, where the orientation of the ceramic reinforcement fibers 1502 is 90°, the at least one processor 1106 is configured to generate a star-based path plan for the automated manipulation of the compaction roller 1102 that starts with a sweep of the compaction roller 1102 from a central reference location 1504 for the ceramic matrix composite ply 1122 and extends at an approximate 45° angle toward a periphery 1506 of the ceramic matrix composite ply 1122. The sweep being between a longitudinal axis 1508 of the layup tool 1124 and a transverse axis 1510 of the layup tool 1124 that intersect at the central reference location 1504 for the ceramic matrix composite ply 1122. In an even yet further example, the at least one processor 1106 is configured to continue generating the star-based path plan with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another even further example, in conjunction with the generation of the path plan, where the orientation of the ceramic reinforcement fibers 1502 is not 90°, the at least one processor 1106 is configured to generate a star-based path plan for the automated manipulation of the compaction roller 1102 that starts with a sweep of the compaction roller 1102 from a central reference location 1504 for the ceramic matrix composite ply 1122 and extends at an approximate 90° angle toward a periphery 1506 of the ceramic matrix composite ply 1122. The sweep being along a longitudinal axis 1508 of the layup tool 1124 or a transverse axis 1510 of the layup tool 1124. The longitudinal axis 1508 and the transverse axis 1510 intersect at the central reference location 1504 for the ceramic matrix composite ply 1122. In an even yet further example, the at least one processor 1106 is configured to continue generating the star-based path plan with additional sweeps of the compaction roller 1102 from the central reference location 1504 that extend toward the periphery 1506 of the ceramic matrix composite ply 1122 at various angles until the ceramic matrix composite ply 1122 is compacted on the layup tool 1124.

In another further example, in conjunction with the generation of the path plan, where the maximum angle of distortion is not greater than the predetermined threshold, the at least one processor 1106 is configured to generate a grid-based path plan for the automated manipulation of the compaction roller 1102. The grid-based path plan includes sweeps of the compaction roller 1102 from a longitudinal axis 1508 of the ceramic matrix composite ply 1122 or a transverse axis 1510 of the ceramic matrix composite ply 1122 toward a periphery 1506 of the ceramic matrix composite ply 1122. The sweeps initially start from a central reference location 1504 for the ceramic matrix composite ply 1122. The longitudinal axis 1508 and the transverse axis 1510 intersect at the central reference location 1504 for the ceramic matrix composite ply 1122. In an even yet further example, the at least one processor 1106 is configured to continue generating the grid-based path plan with additional sweeps of the compaction roller 1102 along the longitudinal axis 1508 or the transverse axis 1510. The additional sweeps being toward the periphery 1506 of the ceramic matrix composite ply 1122 from various locations along the longitudinal axis 1508 or the transverse axis 1510 until the ceramic matrix composite ply 1122 is compacted on the layup tool 1124.

In yet another example of the path planning development environment 1100, the at least one processor 1106 is configured to at least temporarily store the path plan in the at least one data storage device 1118 as a path plan data file 1134. The path plan data file 1134 tailored for compaction of the ceramic matrix composite ply 1122 on the layup tool 1124 using the compaction roller 1102.

In a further example, the at least one processor 1106 and the network interface 1110 are configured to send the path plan data file 1134 to a working path plan repository 1202 in at least one central storage device 1136 via the communication network 1112. The working path plan repository 1202 being accessible to a path plan test bed 1138. The path plan test bed 1138 includes the layup tool 1124, the ceramic matrix composite ply 1122 placed on the layup tool 1124, a test robot control system 1304, a robotic arm 1306 controlled by the test robot control system 1304 and an end effector 1308 on the robotic arm 1306. The end effector 1308 includes the compaction roller 1102. The test robot control system 1304 includes at least one test processor 1310 and associated memory 1312, a network interface 1314 in operative communication with the at least one test processor 1310 and at least one test program storage device 1316 in operative communication with the at least one test processor 1310. The at least one test program storage device 1316 storing a compaction application program 1318. The at least one test processor 1310 is configured to run the compaction application program 1318 on the test robot control system 1304 of the path plan test bed 1138. The compaction application program 1318 uses the path plan data file 1134 from the working path plan repository 1202 for compaction of the ceramic matrix composite ply 1122 on the layup tool 1124. The path plan test bed 1138 is configured for evaluating the compaction of the ceramic matrix composite ply 1122 on the layup tool 1124 to validate the path plan data file 1134 complies with predetermined requirements for the ceramic matrix composite ply 1122 and the layup tool 1124.

In an even further example, the layup tool 1124 includes a working surface 1302 upon which the ceramic matrix composite ply 1122 is placed during the composite manufacturing. In an even yet further example, the working surface 1302 of the layup tool 1124 is three-dimensional. In another even yet further example, the working surface 1302 of the layup tool 1124 includes a curved portion, a double curved portion, a contoured portion, a geometrically-shaped portion, a rising ramp portion, a falling ramp portion, a two-dimensional portion or any other suitable shaped portion in any suitable combination.

In another even further example, the compaction roller 1102 includes an approximately three inch roller, a roller having a width ranging between approximately two inches and approximately four inches, a roller having a width ranging between approximately five inches and approximately seven inches, a roller having a width ranging between approximately eight inches and approximately ten inches, a roller having a width ranging between approximately eleven inches and approximately thirteen inches or any other suitable compaction roller. In yet another even further example, where the evaluating of the compaction is successful, the test robot control system 1304 is configured to send the path plan data file 1134 from the working path plan repository 1202 to a validated path plan repository 1204 accessible to a cell robot control system 1402 of a composite manufacturing layup cell 1400. The cell robot control system 1402 is associated with the compaction roller 1102. In still another even further example, where the evaluating of the compaction is not successful, the test robot control system 1304 is configured to notify the at least one computing device 1104 of the path planning development environment 1100 that the evaluating of the compaction was not successful. The at least one computing device 1104 is configured to run the path planning application program 1116 to generate a revised path plan and a revised path plan data file 1140 by replacing portions of paths in which unacceptable conditions were identified with paths that use a back-and-forth yaw motion while advancing along the path. The at least one computing device 1104 is configured to send the revised path plan data file 1140 to the working path plan repository 1202 in the at least one central storage device 1136 via the communication network 1112. The test robot control system 1304 is configured to run the compaction application program 1318 at the path plan test bed 1138 to evaluate the revised path plan data file 1140.

In another further example, the at least one computing device 1104 is configured for verifying the path plan data file 1134 complies with predetermined standards for such data files and complies with predetermined requirements for the ceramic matrix composite ply 1122 and the layup tool 1124. The at least one computing device 1104 having access to the path plan data file 1134. In an even further example, where the verifying of the path plan data file 1134 is successful, the at least one computing device 1104 is configured to send the path plan data file 1134 to a verified path plan repository 1206 accessible to a cell robot control system 1402 of a composite manufacturing layup cell 1400. The robot control system 1402 is associated with the compaction roller 1102. In another even further example, where the verifying of the path plan data file 1134 is not successful, the at least one computing device 1104 is configured to generate a revised path plan and a revised path plan data file 1140 by replacing portions of paths in which unacceptable conditions were identified with paths that use a back-and-forth yaw motion while advancing along the path. The at least one computing device 1104 is configured to verify the revised path plan data file 1140.

In yet another further example, the at least one computing device 1104 is configured for validating the path plan data file 1134 complies with predetermined requirements for the ceramic matrix composite ply 1122 and the layup tool 1124 by running a compaction simulation application program 1142 on the at least one computing device 1104. The at least one computing device 1104 having access to the path plan data file 1134. In an even further example, where the validating of the path plan data file 1134 is successful, the at least one computing device 1104 is configured to send the path plan data file 1134 to a validated path plan repository 1204 accessible to a cell robot control system 1402 of a composite manufacturing layup cell 1400. The cell robot control system 1402 is associated with the compaction roller 1102. In another even further example, where the validating of the path plan data file 1134 is not successful, the at least one computing device 1104 is configured to generate a revised path plan and a revised path plan data file 1140 by replacing portions of paths in which unacceptable conditions were identified with paths that use a back-and-forth yaw motion while advancing along the path. The at least one computing device 1104 is configured to validate the revised path plan data file 1140 complies with predetermined requirements for the ceramic matrix composite ply 1122 and the layup tool 1124 by the at least one processor 1106 running the compaction simulation application program 1142.

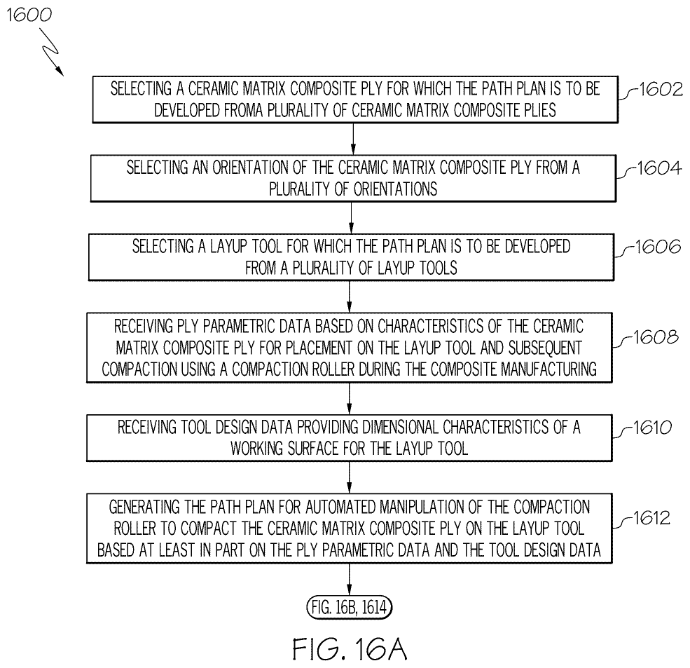

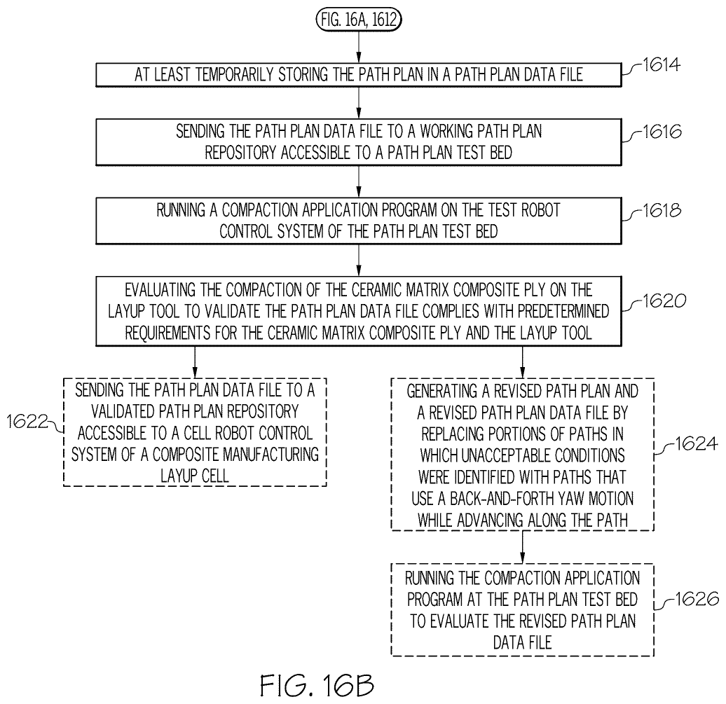

Referring generally to FIGS. 11-14 and 16A-B, by way of examples, the present disclosure is directed to a method 1600 for developing a path plan for rollout compaction of a composite ply during composite manufacturing. FIGS. 16A-B disclose several examples of method 1600. FIG. 11 discloses an example of a path planning development environment 1100 for developing a path plan for rollout compaction of a composite ply during composite manufacturing. FIG. 12 discloses an example of at least one central storage device 1136. FIG. 13 discloses an example of a path plan test bed 1138. FIG. 14 discloses an example of composite manufacturing layup cell 1400.

With reference again to FIGS. 11-14 and 16A-B, in one or more examples, a method 1600 for developing a path plan for rollout compaction of a composite ply during composite manufacturing includes selecting 1602 a ceramic matrix composite ply 1122 for which the path plan is to be developed from a plurality of ceramic matrix composite plies. At 1604, an orientation of the ceramic matrix composite ply 1122 is selected from a plurality of orientations. At 1606, a layup tool 1124 for which the path plan is to be developed is selected from a plurality of layup tools. At 1608, ply parametric data 1120 is received. The ply parametric data 1120 is based on characteristics of the ceramic matrix composite ply 1122 for placement on the layup tool 1124 and subsequent compaction using a compaction roller 1102 during the composite manufacturing. At 1610, tool design data 1132 is received. The tool design data 1132 provides dimensional characteristics of a working surface (1302) for the layup tool (1124). At 1612, the path plan for automated manipulation of the compaction roller 1102 to compact the ceramic matrix composite ply 1122 on the layup tool 1124 is generated based at least in part on the ply parametric data 1120 and the tool design data 1132. At 1614, the path plan is at least temporarily stored in a path plan data file 1134. At 1616, the path plan data file 1134 is sent to a working path plan repository 1202 accessible to a path plan test bed 1138. The path plan test bed 1138 includes the layup tool 1124, the ceramic matrix composite ply 1122 placed on the layup tool 1124, a test robot control system 1304, a robotic arm 1306 controlled by the test robot control system 1304 and an end effector 1308 on the robotic arm 1306. The end effector 1308 includes the compaction roller 1102. At 1618, a compaction application program 1318 is run on the test robot control system 1304 of the path plan test bed 1138. The compaction application program 1318 uses the path plan data file 1134 from the working path plan repository 1202 for compaction of the ceramic matrix composite ply 1122 on the layup tool 1124. At 1620, the compaction of the ceramic matrix composite ply 1122 on the layup tool 1124 is evaluated to validate the path plan data file 1134 complies with predetermined requirements for the ceramic matrix composite ply 1122 and the layup tool 1124.

In another example of the method 1600, the evaluating 1620 of the compaction includes a visual inspection of the compaction, visual imaging of the compaction, analysis of the compaction, comparison of contours of the compacted ceramic matrix composite ply 1122 to contours of the layup tool 1124 or another other suitable evaluating technique in any suitable combination.

In yet another example, where the evaluating 1620 of the compaction is successful, the method 1600 also includes sending 1622 the path plan data file 1134 to a validated path plan repository 1204 accessible to a cell robot control system 1402 of a composite manufacturing layup cell 1400. The cell robot control system 1402 is associated with the compaction roller 1102.

In still another example, where the evaluating 1620 of the compaction is not successful, the method 1600 also includes generating 1624 a revised path plan and a revised path plan data file 1140 by replacing portions of paths in which unacceptable conditions were identified with paths that use a back-and-forth yaw motion while advancing along the path. At 1626, the compaction application program 1318 is run at the path plan test bed 1138 to evaluate the revised path plan data file 1140.

With reference again to FIG. 11, the at least one computing device 1104 may also include a user input device 1144 and/or a user display device 1146. With reference again to FIG. 13, the test robot control system 1304 may also include a user input device 1328 and/or a user display device 1330. With reference again to FIG. 14, the cell robot control system 1402 may include a at least one cell processor 1404 and associated memory 1406, a network interface 1408, at least one cell program storage device 1410, a cell user input device 1412 and a user display device 1414 in any suitable combination. The at least one cell program storage device 1410 may store the compaction application program 1318. The composite manufacturing layup cell 1400 may also include the robotic arm 1306 and the end effector 1308.

Examples of methods 100, 600, 700, 800, 900, 1000, 1600, path planning development environments 1100, central storage devices 1136 and path plan test beds 1138 for developing a path plan for rollout compaction of a composite ply during composite manufacturing may be related to or used in the context of aircraft design and manufacture. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to methods for analysis of fastened structures in the design and manufacture of various types of vehicles and in the design and construction of various types of transportation structures.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provide above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, control system, device, computing device, processor, structure, article, element, component, or hardware “configured to” perform a specified function is indeed capable of performing the specified function without any alteration, rather than merely having potential to perform the specified function after further modification. In other words, the system, apparatus, device, control system, computing device, processor, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, control system, device, computing device, processor, structure, article, element, component, or hardware that enable the system, apparatus, control system, device, computing device, processor, structure, article, element, component, or hardware to perform the specified function without further modification. For purposes of this disclosure, a system, apparatus, device, control system, device, computing device, processor, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

In FIGS. 1-10 and 16A-B, referred to above, the blocks may represent operations, steps, and/or portions thereof, and lines connecting the various blocks do not imply any particular order or dependency of the operations or portions thereof. It will be understood that not all dependencies among the various disclosed operations are necessarily represented. FIGS. 1-10 and 16A-B and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

FIGS. 11-14 and 15A-D, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 11-14 and 15A-D, referred to above, need be included in every example and not all elements, features, and/or components described herein are necessarily depicted in each illustrative example. Accordingly, some of the elements, features, and/or components described and illustrated in FIGS. 11-14 and 15A-D may be combined in various ways without the need to include other features described and illustrated in FIGS. 11-14 and 15A-D, other drawing figures, and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 11-14 and 15A-D, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 11-14 and 15A-D, and such elements, features, and/or components may not be discussed in detail herein with reference to each of FIGS. 11-14 and 15A-D. Similarly, all elements, features, and/or components may not be labeled in each of FIGS. 11-14 and 15A-D, but reference numerals associated therewith may be utilized herein for consistency.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

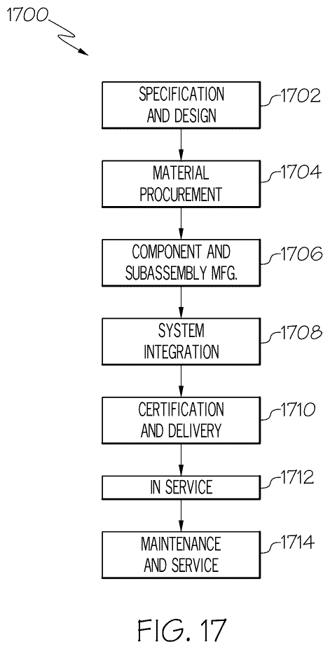

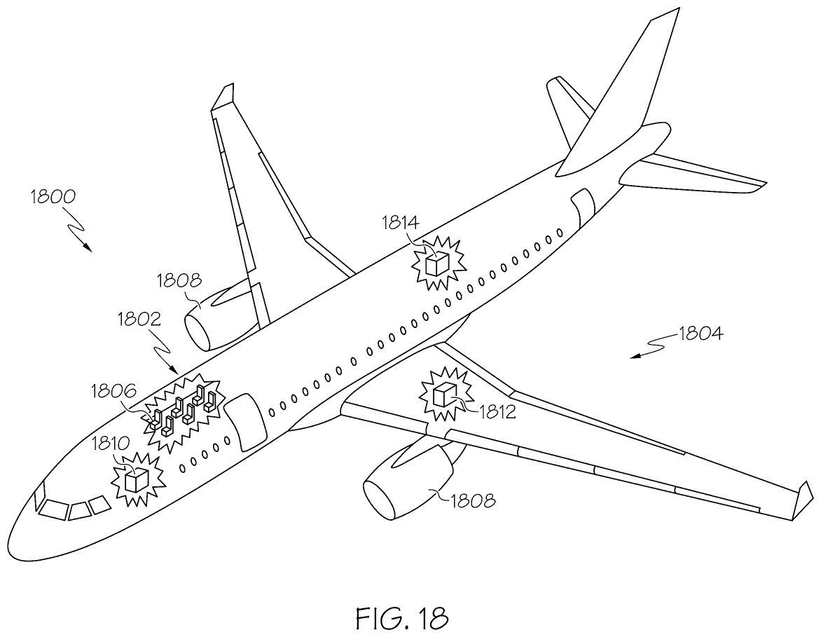

Examples of the subject matter disclosed herein may be described in the context of aircraft manufacturing and service method 1700 as shown in FIG. 17 and aircraft 1800 as shown in FIG. 18. In one or more examples, the disclosed methods and systems for analysis of fastened structures may be used in aircraft manufacturing. During pre-production, the service method 1700 may include specification and design (block 1702) of aircraft 1800 and material procurement (block 1704). During production, component and subassembly manufacturing (block 1706) and system integration (block 1708) of aircraft 1800 may take place. Thereafter, aircraft 1800 may go through certification and delivery (block 1710) to be placed in service (block 1712). While in service, aircraft 1800 may be scheduled for routine maintenance and service (block 1714). Routine maintenance and service may include modification, reconfiguration, refurbishment, etc. of one or more systems of aircraft 1800.

Each of the processes of the service method 1700 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 18, aircraft 1800 produced by the service method 1700 may include airframe 1802 with a plurality of high-level systems 1804 and interior 1806. Examples of high-level systems 1804 include one or more of propulsion system 1808, electrical system 1810, hydraulic system 1812, and environmental system 1814. Any number of other systems may be included. Although an aerospace example is shown, the principles disclosed herein may be applied to other industries, such as the automotive industry. Accordingly, in addition to aircraft 1800, the principles disclosed herein may apply to other vehicles, e.g., land vehicles, marine vehicles, space vehicles, etc.

The disclosed methods and systems for analysis of fastened structures may be employed during any one or more of the stages of the manufacturing and service method 1700. For example, components or subassemblies corresponding to component and subassembly manufacturing (block 1706) may be fabricated or manufactured in a manner similar to components or subassemblies produced while aircraft 1800 is in service (block 1712). Also, one or more examples of the tooling set(s), system(s), method(s), or any combination thereof may be utilized during production stages (block 1706 and block 1708), for example, by substantially expediting assembly of or reducing the cost of aircraft 1800. Similarly, one or more examples of the tooling set, system or method realizations, or a combination thereof, may be utilized, for example and without limitation, while aircraft 1800 is in service (block 1712) and/or during maintenance and service (block 1714).

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the methods 100, 600, 700, 800, 900, 1000, 1600, path planning development environments 1100, central storage devices 1136 and path plan test beds 1138 for developing path plans for rollout compaction of composite plies during composite manufacturing have been shown and described, modifications may occur to those skilled in the art upon reading the specification. The present application includes such modifications and is limited only by the scope of the claims.

1. A method for developing a path plan for rollout compaction of a composite ply during composite manufacturing, comprising:
receiving ply parametric data based on characteristics of a ceramic matrix composite ply for placement on a layup tool and subsequent compaction using a compaction roller during the composite manufacturing; and
generating the path plan for automated manipulation of the compaction roller to compact the ceramic matrix composite ply on the layup tool based at least in part on the ply parametric data, the path plan comprising multiple sweeps of the compaction roller over the ceramic matrix composite ply.

2-15. (canceled)

16. The method of claim 1, further comprising:
selecting the ceramic matrix composite ply for which the path plan is to be developed from a plurality of ceramic matrix composite plies; and
selecting an orientation of the ceramic matrix composite ply from a plurality of orientations.

17. (canceled)

18. The method of claim 1, further comprising:
selecting the layup tool for which the path plan is to be developed from a plurality of layup tools.

19. The method of claim 1, further comprising:
receiving tool design data providing dimensional characteristics of a working surface for the layup tool upon which the ceramic matrix composite ply is placed during the composite manufacturing, and
wherein the generating of the path plan for automated manipulation of the compaction roller is based at least in part on the tool design data.

20-21. (canceled)

22. The method of claim 1, the generating of the path plan comprising:
receiving tool design data providing dimensional characteristics of a working surface for the layup tool upon which the ceramic matrix composite ply is placed during the composite manufacturing;
identifying a maximum shear for the ceramic matrix composite ply based at least in part on the ply parametric data for the ceramic matrix composite ply and the tool design data; and
comparing the maximum shear to a predetermined threshold.

23-24. (canceled)

25. The method of claim 22, where the maximum shear is greater than the predetermined threshold, the generating of the path plan further comprising:
identifying an orientation of ceramic reinforcement fibers within the ceramic matrix composite ply in conjunction with placement of the ceramic matrix composite ply on the layup tool based at least in part on the ply parametric data for the ceramic matrix composite ply; and
comparing the orientation of the ceramic reinforcement fibers to a 90° threshold.

26. The method of claim 25, where the orientation of the ceramic reinforcement fibers is 90°, the generating of the path plan further comprising:
generating a star-based path plan for the automated manipulation of the compaction roller that starts with a sweep of the compaction roller from a central reference location for the ceramic matrix composite ply and extends at an approximate 45° angle toward a periphery of the ceramic matrix composite ply, the sweep being between a longitudinal axis of the layup tool and a transverse axis of the layup tool that intersect at the central reference location for the ceramic matrix composite ply.

27. (canceled)

28. The method of claim 25, where the orientation of the ceramic reinforcement fibers is not 90°, the generating of the path plan further comprising:
generating a star-based path plan for the automated manipulation of the compaction roller that starts with a sweep of the compaction roller from a central reference location for the ceramic matrix composite ply and extends at an approximate 90° angle toward a periphery of the ceramic matrix composite ply, the sweep being along a longitudinal axis of the layup tool or a transverse axis of the layup tool, the longitudinal axis and the transverse axis intersecting at the central reference location for the ceramic matrix composite ply.

29. (canceled)

30. The method of claim 22, where the maximum shear is not greater than the predetermined threshold, the generating of the path plan further comprising:
generating a grid-based path plan for the automated manipulation of the compaction roller, the grid-based path plan comprising sweeps of the compaction roller from a longitudinal axis of the ceramic matrix composite ply or a transverse axis of the ceramic matrix composite ply toward a periphery of the ceramic matrix composite ply, the sweeps initially starting from a central reference location for the ceramic matrix composite ply, the longitudinal axis and the transverse axis intersecting at the central reference location for the ceramic matrix composite ply.

31. (canceled)

32. The method of claim 1, the generating of the path plan comprising:
identifying a maximum angle of distortion for the ceramic matrix composite ply based at least in part on the ply parametric data for the ceramic matrix composite ply; and
comparing (404) the maximum angle of distortion to a predetermined threshold.

33-34. (canceled)

35. The method of claim 32, where the maximum angle of distortion is greater than the predetermined threshold, the generating of the path plan further comprising:
identifying an orientation of ceramic reinforcement fibers within the ceramic matrix composite ply in conjunction with placement of the ceramic matrix composite ply on the layup tool based at least in part on the ply parametric data for the ceramic matrix composite ply; and
comparing the orientation of the ceramic reinforcement fibers to a 90° threshold.

36. The method of claim 35, where the orientation of the ceramic reinforcement fibers is 90°, the generating of the path plan further comprising:
generating a star-based path plan for the automated manipulation of the compaction roller that starts with a sweep of the compaction roller from a central reference location for the ceramic matrix composite ply and extends at an approximate 45° angle toward a periphery of the ceramic matrix composite ply, the sweep being between a longitudinal axis of the layup tool and a transverse axis of the layup tool that intersect at the central reference location for the ceramic matrix composite ply.

37. (canceled)

38. The method of claim 35, where the orientation of the ceramic reinforcement fibers is not 90°, the generating of the path plan further comprising:
generating a star-based path plan for the automated manipulation of the compaction roller that starts with a sweep of the compaction roller from a central reference location for the ceramic matrix composite ply and extends at an approximate 90° angle toward a periphery of the ceramic matrix composite ply, the sweep being along a longitudinal axis of the layup tool or a transverse axis of the layup tool, the longitudinal axis and the transverse axis intersecting at the central reference location for the ceramic matrix composite ply.

39. (canceled)

40. The method of claim 32, where the maximum angle of distortion is not greater than the predetermined threshold, the generating of the path plan further comprising:
generating a grid-based path plan for the automated manipulation of the compaction roller, the grid-based path plan comprising sweeps of the compaction roller from a longitudinal axis of the ceramic matrix composite ply or a transverse axis of the ceramic matrix composite ply toward a periphery of the ceramic matrix composite ply, the sweeps initially starting from a central reference location for the ceramic matrix composite ply, the longitudinal axis and the transverse axis intersecting at the central reference location for the ceramic matrix composite ply.

41. (canceled)

42. The method of claim 1, further comprising:
at least temporarily storing the path plan in a path plan data file, the path plan data file tailored for compaction of the ceramic matrix composite ply on the layup tool using the compaction roller.

43. The method of claim 42, further comprising:
sending the path plan data file to a working path plan repository accessible to a path plan test bed, wherein the path plan test bed comprises the layup tool, the ceramic matrix composite ply placed on the layup tool, a test robot control system, a robotic arm controlled by the test robot control system and an end effector on the robotic arm, wherein the end effector comprises the compaction roller;
running a compaction application program on the test robot control system of the path plan test bed, the compaction application program using the path plan data file from the working path plan repository for compaction of the ceramic matrix composite ply on the layup tool; and
evaluating the compaction of the ceramic matrix composite ply on the layup tool to validate the path plan data file complies with predetermined requirements for the ceramic matrix composite ply and the layup tool.

44-46. (canceled)

47. The method of claim 42, further comprising:
verifying the path plan data file complies with predetermined standards for such data files and complies with predetermined requirements for the ceramic matrix composite ply and the layup tool.

48-50. (canceled)

51. The method of claim 42, further comprising:
validating the path plan data file complies with predetermined requirements for the ceramic matrix composite ply and the layup tool by running a compaction simulation application program on at least one computing device of a path planning development environment (1100), the at least one computing device having access to the path plan data file.

52-53. (canceled)

54. A path planning development environment for developing a path plan for rollout compaction of a composite ply during composite manufacturing, the path planning development environment comprising:
at least one computing device, comprising:
at least one processor and associated memory;
a network interface in operative communication with the at least one processor and a communication network;
at least one application program storage device in operative communication with the at least one processor, the at least one application program storage device storing a path planning application program; and
at least one data storage device in operative communication with the at least one processor,
wherein the at least one processor and the network interface are configured to receive ply parametric data based on characteristics of a ceramic matrix composite ply for placement on a layup tool and subsequent compaction using a compaction roller during the composite manufacturing,
wherein the at least one processor is configured to store the ply parametric data in the at least one data storage device, and
wherein the at least one processor is configured to generate the path plan for automated manipulation of the compaction roller to compact the ceramic matrix composite ply on the layup tool based at least in part on the ply parametric data, the path plan comprising multiple sweeps of the compaction roller over the ceramic matrix composite ply.

55-87. (canceled)

88. A method for developing a path plan for rollout compaction of a composite ply during composite manufacturing, comprising:
selecting a ceramic matrix composite ply for which the path plan is to be developed from a plurality of ceramic matrix composite plies;
selecting an orientation of the ceramic matrix composite ply from a plurality of orientations;
selecting a layup tool for which the path plan is to be developed from a plurality of layup tools;
receiving ply parametric data based on characteristics of the ceramic matrix composite ply for placement on the layup tool and subsequent compaction using a compaction roller during the composite manufacturing;
receiving tool design data providing dimensional characteristics of a working surface for the layup tool;
generating the path plan for automated manipulation of the compaction roller to compact the ceramic matrix composite ply on the layup tool based at least in part on the ply parametric data and the tool design data;
at least temporarily storing the path plan in a path plan data file;
sending the path plan data file to a working path plan repository accessible to a path plan test bed, wherein the path plan test bed comprises the layup tool, the ceramic matrix composite ply placed on the layup tool, a test robot control system, a robotic arm controlled by the test robot control system and an end effector on the robotic arm, wherein the end effector comprises the compaction roller;
running a compaction application program on the test robot control system of the path plan test bed, the compaction application program using the path plan data file from the working path plan repository for compaction of the ceramic matrix composite ply on the layup tool; and
evaluating the compaction of the ceramic matrix composite ply on the layup tool to validate the path plan data file complies with predetermined requirements for the ceramic matrix composite ply and the layup tool.

89-91. (canceled)
